(19) United States
(12) Patent Application Publication
(10) Pub. No.: US 2021/0360747 A1
(43) Pub. Date: Nov. 18, 2021

(54) HEATER AND METHOD FOR MANUFACTURING SAME

(71) Applicant: NIPPON MEKTRON, LTD., Tokyo (JP)

(72) Inventors: Shunsuke AOYAMA, Tokyo (JP); Kazuyuki AZUMA, Tokyo (JP)

(73) Assignee: NIPPON MEKTRON, LTD., Tokyo (JP)

(21) Appl. No.: 17/218,461

(22) Filed: Mar. 31, 2021

(30) Foreign Application Priority Data
May 15, 2020 (JP) 2020-085822

(51) Int. Cl. H05B 3/18; H05B 3/84; B23K 1/008

(52) U.S. Cl. CPC H05B 3/18; H05B 3/84; H05B 2203/017; B23K 1/008; H05B 2203/013

(57) ABSTRACT

Provided is a heater which includes a base film having a metal foil on a surface of the base film, and a resistor. The metal foil forms a heater circuit that generates heat when energized, and the heater circuit is connected in series with the resistor.

### CROSS-REFERENCE TO RELATED APPLICATION

This application claims priority from Japanese Patent Application No. 2020-085822 filed with the Japan Patent Office on May 15, 2020, the entire content of which is hereby incorporated by reference.

### BACKGROUND

### 1. Technical Field

The present disclosure relates to a heater and a method for manufacturing the same.

### 2. Related Art

Conventionally, a film-like heater has been used to heat a windshield of an automobile, or the like (see Japanese Patent No. 5038921 and JP-UM-A-5-64624). In recent years, development of advanced driver assistance systems (ADAS) has progressed. Then, there is an increasing need for the film-like heater to prevent fogging of a camera lens for detection or the windshield. In addition, cameras are becoming smaller. Therefore, it has become necessary to miniaturize the heater. Along with this, it has become necessary to thin wiring used for the heater. As a result, it has become difficult to keep variations in heating temperature due to a dimensional tolerance of the wiring within an allowable range.

In addition, a general film-like heater has a problem such as a large number of manufacturing steps. Hereinafter, the general film-like heater and a method for manufacturing the heater will be described with reference to FIGS. 10A, 10B, 11A, 11B, and 11C. FIGS. 10A, 10B, 11A, 11B, and 11C are manufacturing process diagrams of the general film-like heater.

First, a heater wire 510 is formed using a material that generates heat when energized (see FIG. 10A). Examples of materials used for the heater wire 510 include alloys and pure metals such as nickel-chromium alloys, SUS, aluminum, platinum, iron, and nickel. Next, a first insulating film 521 and a second insulating film 522 are respectively provided on two surfaces of the heater wire 510. The first insulating film 521 and the second insulating film 522 sandwiching the heater wire 510 are bonded by an adhesive layer 523 provided between the films (see FIG. 10B). FIG. 10A illustrates a plan view of the heater wire 510. FIG. 10B is a schematic cross-sectional view illustrating an intermediate product in a process for manufacturing the heater.

Subsequently, an electronic component 530 is attached to a surface of the first insulating film 521 so as to be electrically connected to the heater wire 510 (see FIG. 11A). In an illustrated example, the insulating film to which only one electronic component 530 is attached is illustrated. However, a plurality of the electronic components may be attached. An example of the electronic component 530 is a thermal fuse. Thereafter, a wire harness 540 is electrically connected to the heater wire 510 by various methods such as rivets or soldering (see FIG. 11B). Then, a connector 550 is electrically connected to an end of the wire harness 540 via a crimp pin (not shown). The connector 550 is connected to a power source for energizing the heater wire 510 or a device including a control device for controlling the temperature. The heater 500 is obtained by the above manufacturing process. FIGS. 11A and 11B are plan views of the intermediate product in the process for manufacturing the heater. FIG. 11C is a plan view of the finished heater 500. When the heater 500 is obtained by the above manufacturing process, a step of attaching the wire harness 540 and a step of attaching the connector 550 are required in addition to a step of attaching the electronic component 530. Therefore, a large number of manufacturing steps are included.

### SUMMARY

A heater according to a present embodiment includes a base film having a metal foil on a surface of the base film, and a resistor, in which the metal foil forms a heater circuit that generates heat when energized, and the heater circuit is connected in series with the resistor.

### BRIEF DESCRIPTION OF THE DRAWINGS

FIGS. 1A and 1B are circuit diagrams of a heater according to the present embodiment and a heater according to a reference example;

FIGS. 2A and 2B are graphs illustrating change in voltage value with respect to elapsed time in the heater according to this embodiment and the heater according to the reference example;

FIGS. 3A and 3B are graphs illustrating change in current value with respect to the elapsed time in the heater according to this embodiment and the heater according to the reference example;

FIGS. 4A and 4B are graphs illustrating change in temperature with respect to the elapsed time in the heater according to this embodiment and the heater according to the reference example;

FIGS. 5A and 5B are manufacturing process diagrams of the heater including a flexible printed wiring board according to this embodiment;

FIGS. 6A and 6B are manufacturing process diagrams of the heater including the flexible printed wiring board according to this embodiment;

FIGS. 7A and 7B are manufacturing process diagrams of the heater including the flexible printed wiring board according to this embodiment;

FIG. 8 is a manufacturing process diagram of the heater including the flexible printed wiring board according to this embodiment;

FIGS. 9A to 9C are manufacturing process diagrams of the heater including the flexible printed wiring board according to this embodiment;

FIGS. 10A and 10B are manufacturing process diagrams of a general film-like heater; and

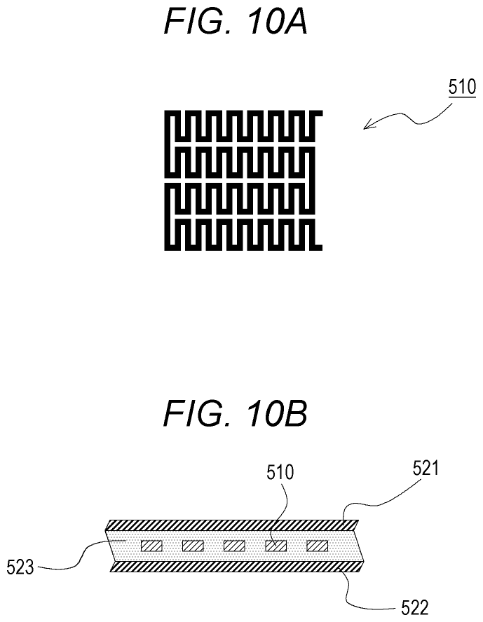

FIGS. 11A to 11C are manufacturing process diagrams of the general film-like heater.

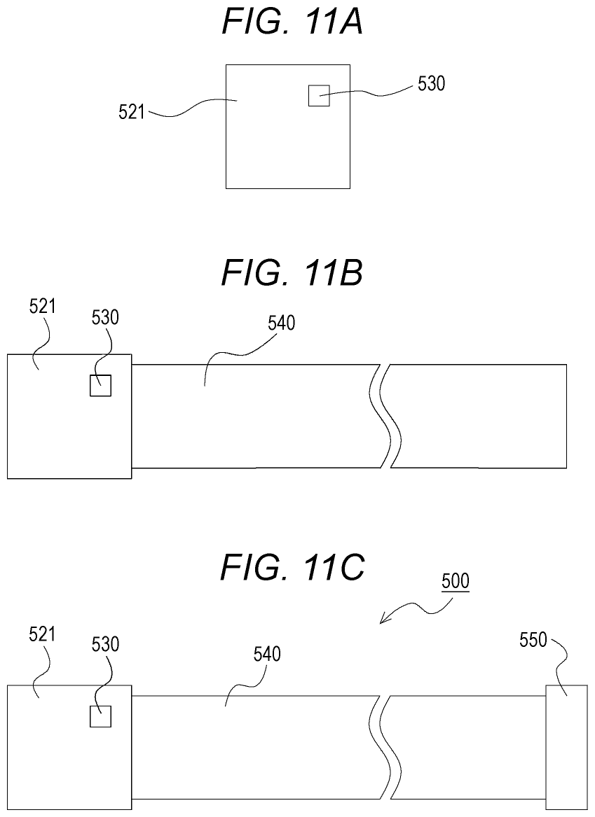

An object of the present disclosure is to provide a heater including a flexible printed wiring board, in which variations in heating temperature can be suppressed and the number of manufacturing steps can be reduced, and a method for manufacturing the heater.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the present embodiment, the following means are employed in order to solve the above problems.

Specifically, a heater according to the present embodiment includes a base film having a metal foil on a surface of the base film, and a resistor. The metal foil forms a heater circuit that generates heat when energized, and the heater circuit is connected in series with the resistor.

According to this embodiment, the resistor is connected in series with the heater circuit. Therefore, a voltage applied to the entire heater is divided between the heater circuit and the resistor. As a result, the voltage is applied to each of the heater circuit and the resistor. When a dimension of wiring constituting the heater circuit is smaller than a reference value within a dimensional tolerance, a voltage value applied to the heater circuit is also increased by an amount that a resistance value of the heater circuit is greater than the reference value. Thus, it is possible to suppress a decrease in current value by the wiring thinner than the reference value. In contrast, when the dimension of the wiring constituting the heater circuit is greater than the reference value within the dimensional tolerance, the voltage value applied to the heater circuit is also reduced by an amount that the resistance value of the heater circuit is smaller than the reference value. Thus, it is possible to suppress an increase in the current value by the wiring thicker than the reference value.

Further, a method for manufacturing a heater according to the present embodiment, the heater including a flexible printed wiring board, includes an etching step, a laminating step, and a reflow step in this order. The etching step includes etching of a base film having a metal foil on a surface of the base film, and the etching forms a heater circuit that generates heat when energized and an energizing portion that energizes the heater circuit, the heater circuit and the energizing portion being made of a part of the metal foil, in the laminating step, a cover film covering a surface of the metal foil is provided, and in the reflow step, a resistor connected in series with the heater circuit and a connector capable of being electrically connected to the energizing portion are provided by reflow soldering.

According to this embodiment, the heater circuit and the energizing portion are formed by the etching step. Therefore, the number of manufacturing steps can be reduced. Further, in the reflow step, attachment of the resistor and attachment of the connector can be performed. Therefore, the number of manufacturing steps can be further reduced.

As described above, according to this embodiment, it is possible to suppress variations in heating temperature and reduce the number of manufacturing steps.

This embodiment will be described in detail exemplary below with reference to the drawings. However, the dimensions, materials, shapes, relative arrangements, and the like of components described in this embodiment are not intended to limit the scope of this embodiment to them unless otherwise specified.

### Embodiment

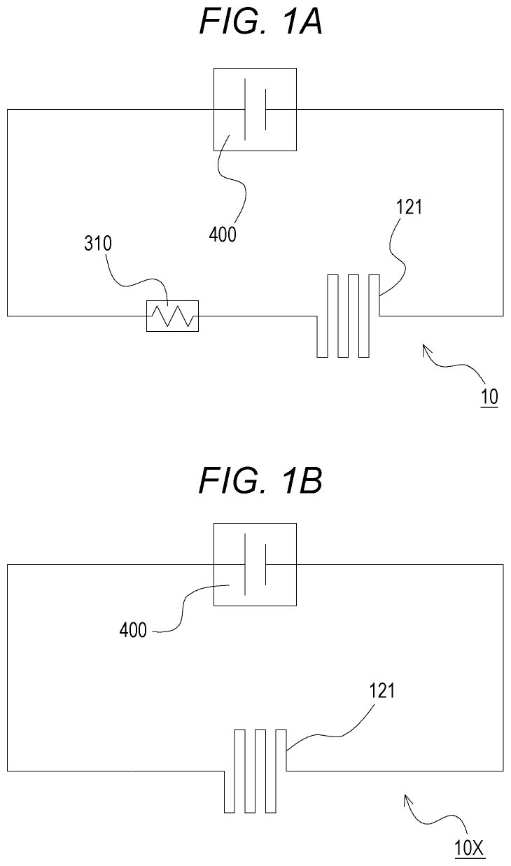

A heater including a flexible printed wiring board according to this embodiment and a method for manufacturing the heater will be described with reference to FIGS. 1A to 9C. A heater 10 according to this embodiment can be suitably used for heating a camera lens for detection or a windshield. Further, the heater 10 according to this embodiment can be applied not only to heat various members constituting an automobile but also to heat various devices other than the automobile. The heater 10 according to this embodiment has flexibility. Therefore, the heater 10 can be bent in various directions. Therefore, the heater 10 can be attached along a curved surface even on a curved portion and used.

Heater

A schematic configuration of the heater including the flexible printed wiring board according to this embodiment will be described with reference to FIGS. 1A and 1B. FIG. 1A is a circuit diagram briefly illustrating the heater including the flexible printed wiring board according to this embodiment connected to a power source. FIG. 1B is a circuit diagram briefly illustrating the heater including the flexible printed wiring board according to a reference example connected to the power supply.

The heater 10 according to this embodiment includes a heater circuit 121 that generates heat when energized and a resistor (a chip resistor 310 in this embodiment) connected in series with the heater circuit 121. A voltage (constant voltage) is applied from a power supply 400 to the heater 10 configured in this way. Then, the heater circuit 121 generates heat. A heater 10X according to the reference example illustrated in FIG. 1B also includes the heater circuit 121 that generates heat when energized. The heater 10X according to the reference example is different from the heater of this embodiment only in that it does not include the resistor. The voltage (constant voltage) is also applied from the power supply 400 to the heater 10X according to the reference example configured in this way. Then, the heater circuit 121 generates heat. Advantages of the heater according to this embodiment

In general, in various products, the dimensions of parts vary due to various influences including the materials and manufacturing steps. Therefore, the dimensional tolerance is set for the dimension of each part with respect to a target design value. A heater containing a heater wire made of an alloy as described in the related art has a relatively large size. Therefore, influence of the dimensional tolerance on the heating temperature is small. In contrast, the wiring of the heater including the flexible printed wiring board is made of a metal foil such as a copper foil. Therefore, the wiring constituting the heater circuit 121 can be thinned. On the other hand, if the wiring is thinned, the influence of the dimensional tolerance on the heating temperature is large. Therefore, in the heater 10 according to this embodiment, as described above, a configuration including the resistor (chip resistor 310) connected in series with the heater circuit 121 is employed. Thus, it is possible to suppress the variations in the heating temperature due to the dimensional tolerance of the wiring constituting the heater circuit 121. Hereinafter, reasons why the variations in the heating temperature can be suppressed will be described.

Assuming that the voltage of the power supply 400 is E[V], the resistance value of the heater circuit 121 is R1[Ω], and the resistance value of the resistor (chip resistor 310) is R2[Ω], a voltage (divided voltage) V1 applied to the heater circuit 121 and a voltage (divided voltage) V2 applied to the resistor have the following relationships.

V1=(R1/(R1+R2))×E[V]

V2=(R2/(R1+R2))×E[V]

Here, when the dimension of the wiring constituting the heater circuit 121 is smaller than the reference value within the dimensional tolerance, the voltage value V1 applied to the heater circuit 121 is also increased by an amount that the resistance value R1 of the heater circuit 121 is greater than the reference value. Thus, it is possible to suppress the decrease in the current value due to the dimension of the wiring being smaller than the reference value. In contrast, when the dimension of the wiring constituting the heater circuit 121 is greater than the reference value within the dimensional tolerance, the voltage value V1 applied to the heater circuit 121 is also reduced by an amount that the resistance value R1 of the heater circuit 121 is smaller than the reference value. Thus, it is possible to suppress the increase in the current value due to the dimension of the wiring being greater than the reference value. Therefore, it is possible to suppress the variations in the heating temperature due to the dimensional tolerance of the wiring constituting the heater circuit 121.

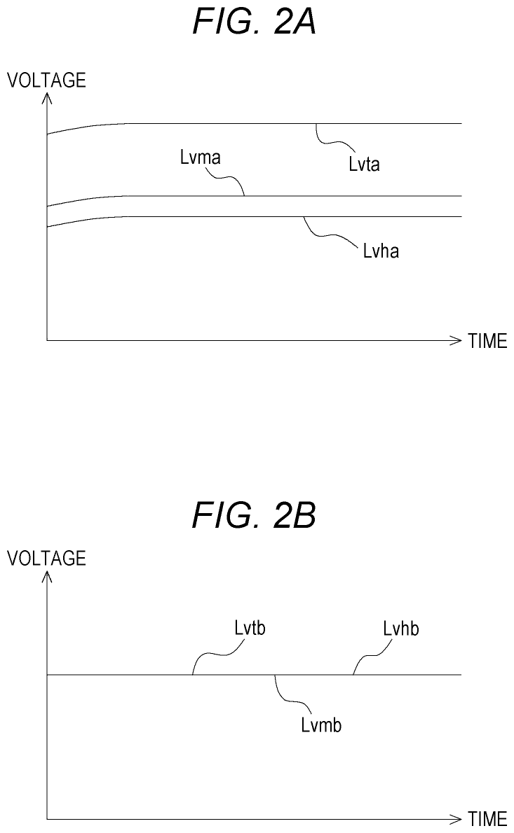

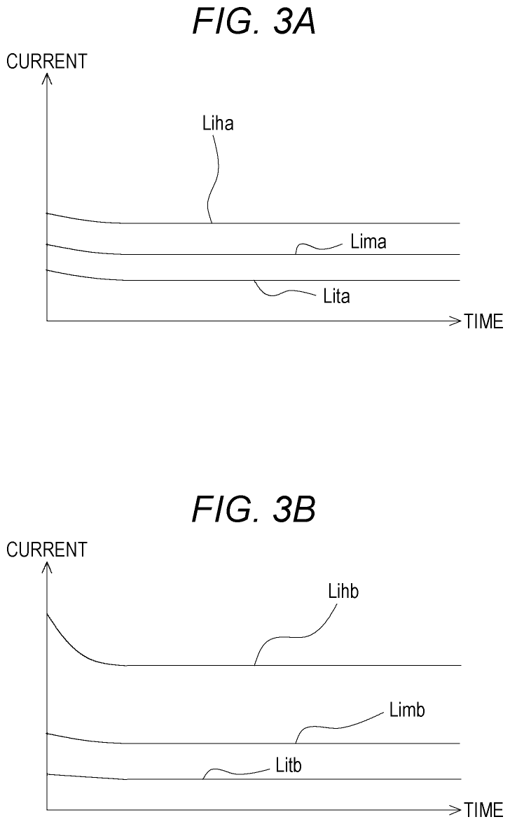

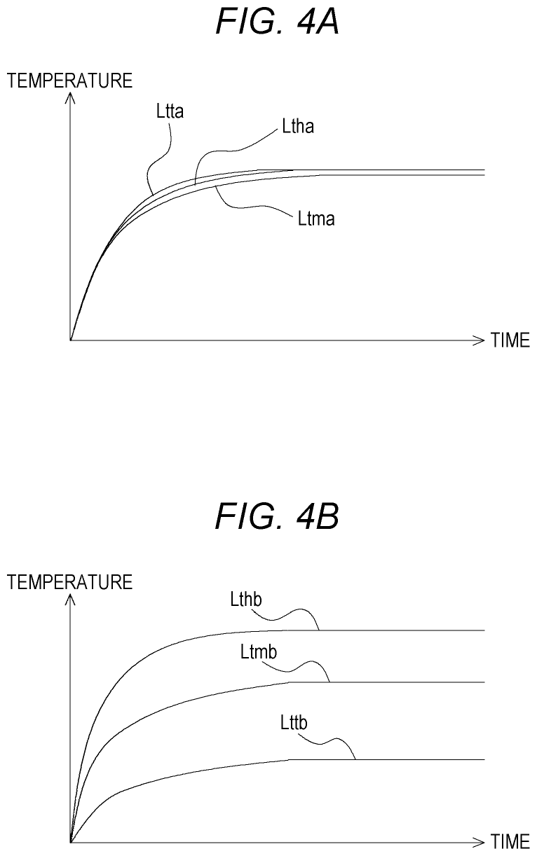

This point will be described in more detail with reference to FIGS. 2A to 4B. FIGS. 2A and 2B are graphs illustrating change in the voltage value in the heater circuit with respect to elapsed time after the voltage is applied to the heater. FIG. 2A illustrates a case of the heater according to this embodiment. FIG. 2B illustrates a case of the above reference example. FIGS. 3A and 3B are graphs illustrating change in the current value in the heater circuit with respect to the elapsed time after the voltage is applied to the heater. FIG. 3A illustrates the case of the heater according to this embodiment. FIG. 3B illustrates the case of the above reference example. FIGS. 4A and 4B are graphs illustrating change in temperature in the heater circuit with respect to the elapsed time after the voltage is applied to the heater. FIG. 4A illustrates the case of the heater according to this embodiment. FIG. 4B illustrates the case of the above reference example.

A graph Lvma in FIG. 2A shows a case where the wiring in the heater circuit 121 has a dimension of the reference value. A graph Lvta shows a case where the wiring is the thinnest within the dimensional tolerance. A graph Lvha shows a case where the wiring is the thickest within the dimensional tolerance. A graph Lvmb in FIG. 2B shows the case where the wiring in the heater circuit 121 has the dimension of the reference value. A graph Lvtb shows the case where the wiring is the thinnest within the dimensional tolerance. A graph Lvhb shows the case where the wiring is the thickest within the dimensional tolerance.

When the resistor is not provided as in the reference example, the voltage from the power supply 400 is directly applied to the heater circuit 121. Therefore, the same voltage is applied to the heater circuit 121 regardless of the dimension of the wiring. In contrast, in the case of the heater 10 according to this embodiment, since the resistor is provided, the thinner the wiring in the heater circuit 121, the larger the voltage applied to the heater circuit 121.

A graph Lima in FIG. 3A shows the case where the wiring in the heater circuit 121 has the dimension of the reference value. A graph Lita shows the case where the wiring is the thinnest within the dimensional tolerance. A graph Liha shows the case where the wiring is the thickest within the dimensional tolerance. A graph Limb in FIG. 3B shows the case where the wiring in the heater circuit 121 has the dimension of the reference value. A graph Litb shows the case where the wiring is the thinnest within the dimensional tolerance. A graph Lihb shows the case where the wiring is the thickest within the dimensional tolerance.

In the case of the reference example, as described above, the same voltage is applied to the heater circuit 121 regardless of the dimension of the wiring. Therefore, the thicker the wiring is, the smaller the resistance value is. As a result, an amount of current is increased. Then, variations in the current value due to a difference in thickness of the wiring are also increased. In addition, since heat is generated by energization, the higher the temperature, the larger the resistance value. Therefore, the current value becomes constant after the current value gradually decreases for a predetermined time from start of energization. In the reference example, when the wiring is thick, the change in the current value is remarkable. On the other hand, also in the case of the heater 10 according to this embodiment, the thicker the wiring, the larger the current value. However, the applied voltage is increased as the wiring is thinner. Therefore, the variations in the current value due to the difference in the thickness of the wiring is small. In addition, the change in the current value at an initial stage of energization can also be suppressed.

A graph Ltma in FIG. 4A shows the case where the wiring in the heater circuit 121 has the dimension of the reference value. A graph Ltta shows the case where the wiring is the thinnest within the dimensional tolerance. A graph Ltha shows the case where the wiring is the thickest within the dimensional tolerance. A graph Ltmb in FIG. 4B shows the case where the wiring in the heater circuit 121 has the dimension of the reference value. A graph Lttb shows the case where the wiring is the thinnest within the dimensional tolerance. A graph Lthb shows the case where the wiring is the thickest within the dimensional tolerance.

In the case of the reference example, the voltage applied to the heater circuit 121 is the same regardless of the dimension of the wiring. Further, the thicker the wiring, the larger the amount of current. Therefore, variations in the temperature of the heater circuit 121 due to the dimensional tolerance of the wiring are large. In contrast, in the case of the heater 10 according to this embodiment, the thinner the wiring, the larger the voltage applied to the heater circuit 121. Further, the amount of current is reduced. On the other hand, the thicker the wiring, the smaller the voltage applied to the heater circuit 121. Further, the amount of current is increased. Thus, as illustrated in FIG. 4A, the variations in the temperature due to the dimensional tolerance of the wiring can be reduced. As described above, with the heater 10 according to this embodiment, it is possible to suppress the variations in the heating temperature due to the dimensional tolerance of the wiring constituting the heater circuit 121. Further, in the case of the heater 10 according to the present embodiment, since the applied voltage is controlled to be different depending on the thickness of the wiring, it is possible to suppress a decrease in the heating temperature with an increase in the resistance value due to increase in the temperature of the heater circuit 121. Method for manufacturing heater including flexible printed wiring board according to this embodiment

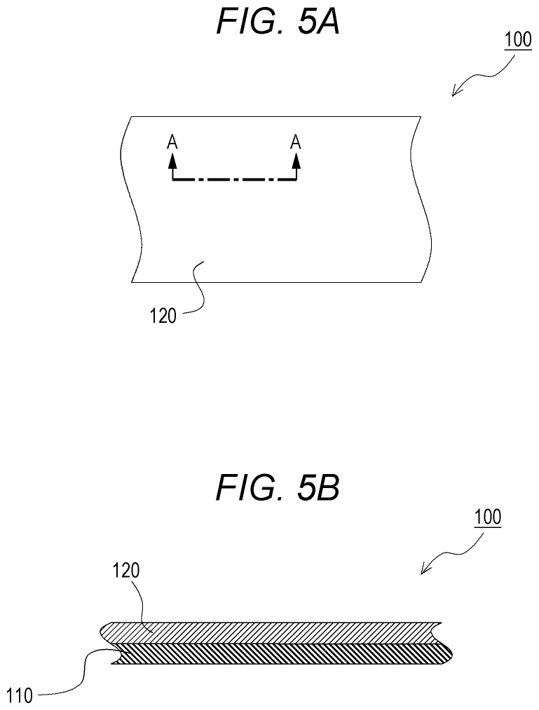

The method for manufacturing the heater including the flexible printed wiring board will be described in an order of the manufacturing steps with reference to FIGS. 5A to 9C.

Material

FIGS. 5A and 5B illustrate a material 100 used for manufacturing the heater 10 according to this embodiment. FIG. 5A is a plan view illustrating a part of the material 100. FIG. 5B is a schematic cross-sectional view of the material 100 (A-A cross-sectional view in FIG. 5A).

The material 100 is generally called a copper-clad laminate and is commercially available. The material 100 is made of a base film 110 having a metal foil 120 on its surface. The base film 110 is made of an insulating resin material having flexibility (for example, polyimide or polyethylene naphthalate). Further, the metal foil 120 is made of copper foil. Since the material 100 formed in this way has flexibility, it can be bent in various directions.

### Etching Step

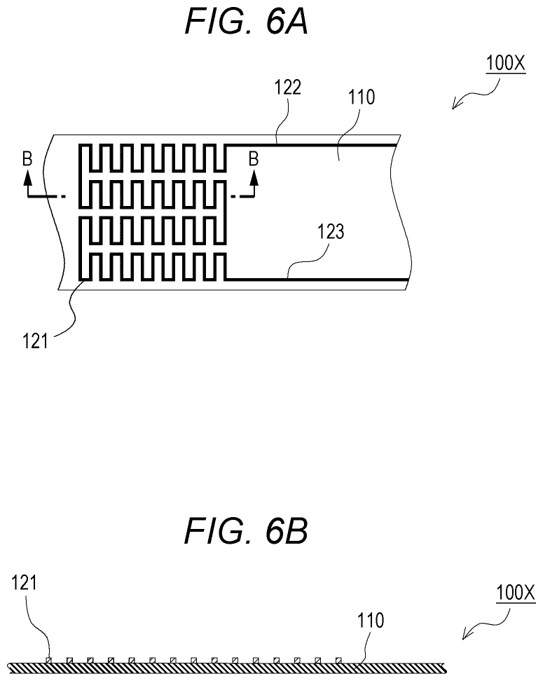

Using a technique such as photolithography, a resist pattern (mask portion) for forming the heater circuit 121 and energizing portions 122 and 123 is formed on one side of the material 100. Thereafter, etching is performed. This removes unnecessary copper foil. In this way, the heater circuit 121 and the energizing portions 122 and 123 are formed. That is, the heater circuit 121 and the energizing portions 122 and 123 are formed by a part of the metal foil 120. The heater circuit 121 and the energizing portions 122 and 123 are formed at substantially the same time by etching. FIGS. 6A and 6B illustrate a first intermediate product 100X after the etching step has been performed. FIG. 6A is a plan view of the first intermediate product 100X. FIG. 6B is a cross-sectional view of the first intermediate product 100X (B-B cross-sectional view in FIG. 6A).

In this embodiment, the heater wire in the heater circuit 121 is provided so that a line width thereof is constant. Further, the heater circuit 121 is configured to be provided with a region in which at least one row of heater wire meanders at equal intervals (see FIG. 6A). In this embodiment, four rows of meandering regions are provided. However, it goes without saying that a pattern of the heater circuit 121 is not limited to an illustrated example. A method for forming the resist pattern is not limited to photolithography. Various known techniques can be employed.

### Laminating Step

After the etching step, a cover film 211 that covers a surface of the metal foil 120 (the heater circuit 121 and the energizing portions 122 and 123) is provided. The cover film 211 is attached to the base film 110 by a pressure-sensitive adhesive layer 212 so as to sandwich the heater circuit 121 and the energizing portions 122 and 123. Like the base film 110, the cover film 211 is also made of the insulating resin material having flexibility. The cover film 211 is provided with openings 211a and 211b.

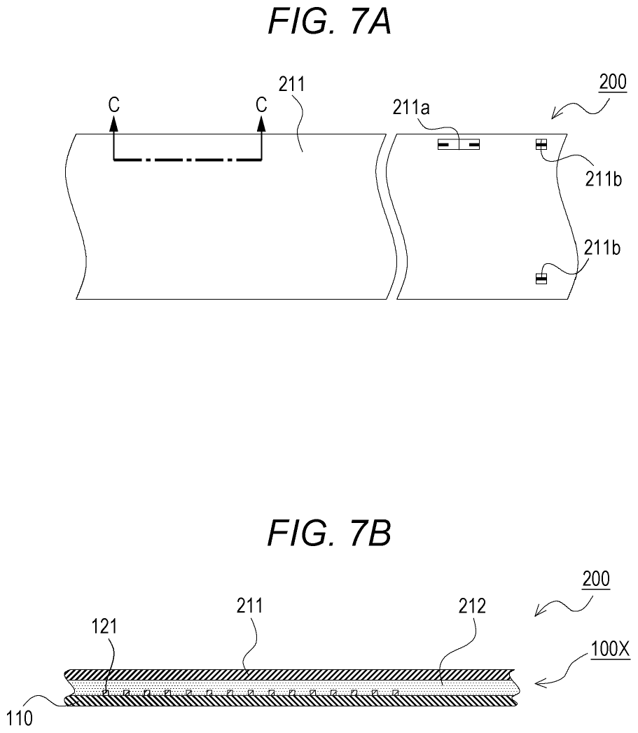

FIGS. 7A and 7B illustrate a second intermediate product 200 after the laminating step has been performed. FIG. 7A is a plan view of the second intermediate product 200. FIG. 7B is a cross-sectional view of the second intermediate product 200 (C-C cross-sectional view in FIG. 7A). Various known techniques can be employed as a laminating method for providing the cover film 211. Therefore, description thereof will be omitted. The second intermediate product 200 corresponds to the flexible printed wiring board.

### Reflow Step (Mounting Step)

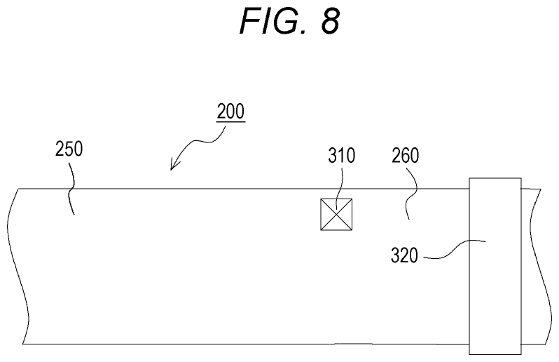

After the laminating step, the chip resistor 310 and a connector 320 are attached to the flexible printed wiring board which is the second intermediate product 200. First, a portion where the metal foil 120 (corresponding to the energizing portions 122 and 123) is exposed through the openings 211a and 211b is subjected to surface treatment such as gold plating or water-soluble preflux treatment. Thereafter, soldering is performed in a reflow furnace. Thus, various components are attached thereto. That is, in this embodiment, the chip resistor 310 is connected to the energizing portion 122 through the opening 211a by reflow soldering. Then, the connector 320 is connected (connected so as to be electrically connectable) to the energizing portions 122 and 123 through the opening 211b. Therefore, attachment of the chip resistor 310 and attachment of the connector 320 can be performed at substantially the same time in one step. FIG. 8 illustrates the second intermediate product 200 after the reflow step has been performed. FIG. 8 is a plan view of the intermediate product. In this embodiment, a case where the chip resistor 310 and the connector 320 are attached in the reflow step has been described as an example, but other electronic components can also be attached at the same time. For example, a surface mount type thermal fuse can be attached to the heater circuit 121.

### Cutting Step

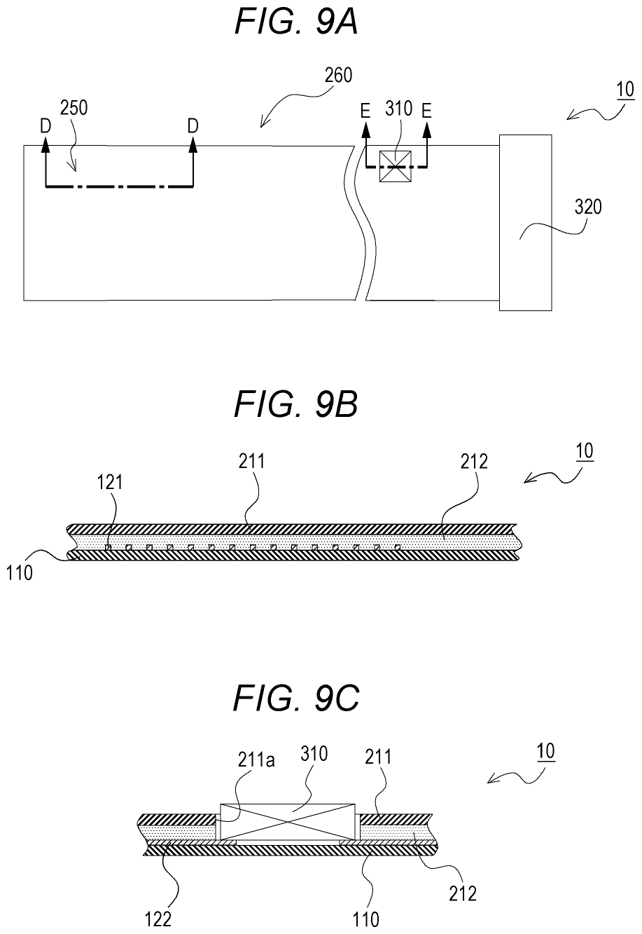

After the reflow step, as illustrated in FIGS. 9A, 9B, and 9C, the finished heater 10 is obtained by being cut so that an outer shape thereof is punched out. Note that a plurality of heaters 10 can be manufactured from one material 100. FIG. 9A is a plan view of the finished heater 10. FIG. 9B is a D-D cross-sectional view in FIG. 9A. FIG. 9C is an E-E cross-sectional view in FIG. 9A. The schematic configuration of the heater according to this embodiment has already been described with reference to FIG. 1A. Hereinafter, the configuration of the heater 10 will be described in more detail.

The heater 10 according to this embodiment includes a heating device 250 for heating a portion to be heated, an electrical wiring portion 260, the chip resistor 310, and the connector 320 provided at an end of the electrical wiring portion 260. The connector 320 is provided to be connected to the power supply 400 for energizing the heater circuit 121. The power supply 400 is generally provided in a device for performing various controls.

Next, an internal configuration of the heating device 250 and the electrical wiring portion 260 in the heater 10 will be described. The heater 10 according to this embodiment includes the base film 110, the heater circuit 121 provided on one side of the base film 110, and the energizing portions 122 and 123 (see also FIG. 6A). The heater circuit 121 is configured to be energized and generate heat by the power supply 400 connected to the connector 320, through the energizing portions 122 and 123.

The above heating device 250 corresponds to a region where the heater circuit 121 is provided. Further, the above electrical wiring portion 260 corresponds to a region where the energizing portions 122 and 123 are provided.

As described above, in the heater 10 according to this embodiment, the metal foil 120 provided on the surface of the base film 110 forms the heater circuit 121 that generates heat when energized. Further, the heater 10 according to this embodiment is provided with the chip resistor 310 as the resistor connected in series with the heater circuit 121.

Advantages of Method for Manufacturing Heater Including Flexible Printed Wiring Board According to this Embodiment

According to the heater 10 including the flexible printed wiring board and the method for manufacturing the heater according to this embodiment, the heater circuit 121 and the energizing portions 122 and 123 are formed by the etching step. Thus, the number of manufacturing steps can be reduced. Therefore, a step of attaching a wire harness as in a conventional case is unnecessary. Therefore, the number of components can be reduced. At the same time, the number of manufacturing steps can be reduced. Further, attachment of the chip resistor 310 and attachment of the connector 320 can be performed in the reflow step. Therefore, the number of manufacturing steps can be further reduced.

### Others

The heater described in the above embodiment includes the flexible printed wiring board in which the metal foil 120 is provided only on one side of the base film 110. However, this embodiment can also be applied to a flexible printed wiring board provided with metal foils on two sides of the base film. In this case, heater circuits may be provided on the two sides of the base film. Alternatively, the heater circuit may be provided on only one side of the base film, and the other surface may have another function. Further, in the above embodiment, the chip resistor is described as the resistor. However, the resistor in this embodiment is not limited to the chip resistor. Various resistors such as axial resistors can be employed.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A heater comprising a base film having a metal foil on a surface of the base film, and a resistor, wherein
the metal foil forms a heater circuit that generates heat when energized, and
the heater circuit is connected in series with the resistor.

2. A method for manufacturing a heater, comprising an etching step, a laminating step, and a reflow step in this order, wherein
the etching step includes etching of a base film having a metal foil on a surface of the base film, and the etching forms a heater circuit that generates heat when energized and an energizing portion that energizes the heater circuit, the heater circuit and the energizing portion being made of a part of the metal foil,
in the laminating step, a cover film covering a surface of the metal foil is provided, and
in the reflow step, a resistor connected in series with the heater circuit and a connector capable of being electrically connected to the energizing portion are provided by reflow soldering.
